(19) United States
(12) Patent Application Publication
(10) Pub. No.: US 2021/0097028 A1
(43) Pub. Date: Apr. 1, 2021

(54) Information Processing Apparatus And Information Processing System

(71) Applicant: FUJITSU CLIENT COMPUTING LIMITED, Kawasaki-Shi (JP)

(72) Inventors: Itaru HIRAKI, Kanagawa (JP); Hiroshi YOKOZAWA, Kanagawa (JP); Hiroshi TORIMARU, Kanagawa (JP); Nobutaka ISHIDERA, Kanagawa (JP)

(21) Appl. No.: 17/001,980

(22) Filed: Aug. 25, 2020

(30) Foreign Application Priority Data
Sep. 30, 2019 (JP) 2019-178602

(51) Int. Cl. G06F 16/17

(52) U.S. Cl. CPC G06F 16/1724

(57) ABSTRACT

An information processing apparatus refers to management information in which an identifier of each of a plurality of dispersed file fragments obtained by dividing an original file and distributedly stored in a plurality of storage devices and a path indicative of a storage location of each of the plurality of dispersed file fragments are recorded in association with an identifier of the original file. Next, the information processing apparatus displays the identifier of the original file. Next, when a selection operation is performed on the identifier of the original file, the information processing apparatus acquires the plurality of dispersed file fragments corresponding to the original file on the basis of the identifier of each of the plurality of dispersed file fragments and the path. Furthermore, the information processing apparatus combines the plurality of dispersed file fragments to generate the original file.

### CROSS-REFERENCE TO RELATED APPLICATION

This application is based upon and claims the benefit of priority of the prior Japanese Patent Application No. 2019-178602, filed on Sep. 30, 2019, the entire contents of which are incorporated herein by reference.

### FIELD

The embodiments discussed herein relate to an information processing apparatus and an information processing system.

### BACKGROUND

In order to perform a task outside an office, a user may carry out a user terminal and edit a file. If the user terminal in which confidential information is stored is stolen, then the information may leak out. In order to prevent the information from leaking out from the user terminal, data may be divided and stored by secret sharing.

With data division by secret sharing, an original file is encrypted and is divided into a plurality of dispersed file fragments. If the user wants to use the original file, then the user terminal combines the plurality of dispersed file fragments to restore the original file. For example, one of two dispersed file fragments obtained by dividing an original file in two is stored in the user terminal and the other dispersed file fragment is stored in another device such as a smartphone. In this case, it is unable to restore the original file from the one dispersed file fragment stored in the user terminal even if the user terminal is stolen. This prevents information from leaking out.

For example, a data division control program is proposed as a technique regarding data division. The data division control program calculates the division ratio of data to be accessed on the basis of access conditions and available capacity of a first storage device and divides the data in accordance with the calculated division ratio.

See, for example, Japanese Laid-open Patent Publication No. 2016-18225.

If the dispersed file fragments are stored in the user terminal and another device other than the user terminal respectively, then the user terminal may obtain the dispersed file fragment from another device at start time and generate the original file. By doing so, the user is able to grasps the original file whose dispersed file fragments are carried out.

In this case, however, the original file not divided is stored in the user terminal which has been started to operate. Accordingly, if the user terminal which has started is stolen, the original file may leak out.

### SUMMARY

According to an aspect, there is provided an information processing apparatus including a memory and a processor which is connected to the memory, which refers to management information in which an identifier of each of a plurality of dispersed file fragments obtained by dividing an original file and distributedly stored in a plurality of storage devices and a path indicative of a storage location of each of the plurality of dispersed file fragments are recorded in association with an identifier of the original file, which displays the identifier of the original file, which acquires, upon selection of the identifier of the original file, the plurality of dispersed file fragments corresponding to the original file based on the identifier of each of the plurality of dispersed file fragments and the path, and which combines the plurality of dispersed file fragments to generate the original file.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an information processing system according to a first embodiment;

FIG. 2 illustrates an example of the structure of a system according to a second embodiment;

FIG. 3 illustrates an example of a hardware configuration of a user terminal;

FIG. 4 illustrates an example of a hardware configuration of a smartphone;

FIG. 5 is a block diagram illustrative of an example of the functions of the user terminal;

FIG. 6 illustrates an example of management information;

FIGS. 7A through 7C illustrate an example of a display screen;

FIG. 8 illustrates an example of a method for opening and closing an original file;

FIG. 9 illustrates an example of a method for updating an original file;

FIG. 10 illustrates an example of a method for copying a dispersed file fragment to the smartphone;

FIG. 11 is a flow chart illustrative of an example of a procedure for registering management information;

FIG. 12 is a flow chart illustrative of an example of a procedure for copying a dispersed file fragment;

FIG. 13 is a flow chart illustrative of an example of a procedure for updating a server file;

FIG. 14 is a flow chart illustrative of an example of a procedure for manipulating a file; and

FIG. 15 is a flow chart illustrative of an example of a procedure for saving a file.

### DESCRIPTION OF EMBODIMENTS

Embodiments will now be described by reference to the accompanying drawings. As long as contradiction does not occur, a plurality of embodiments may be combined and implemented.

### First Embodiment

First, a first embodiment will be described.

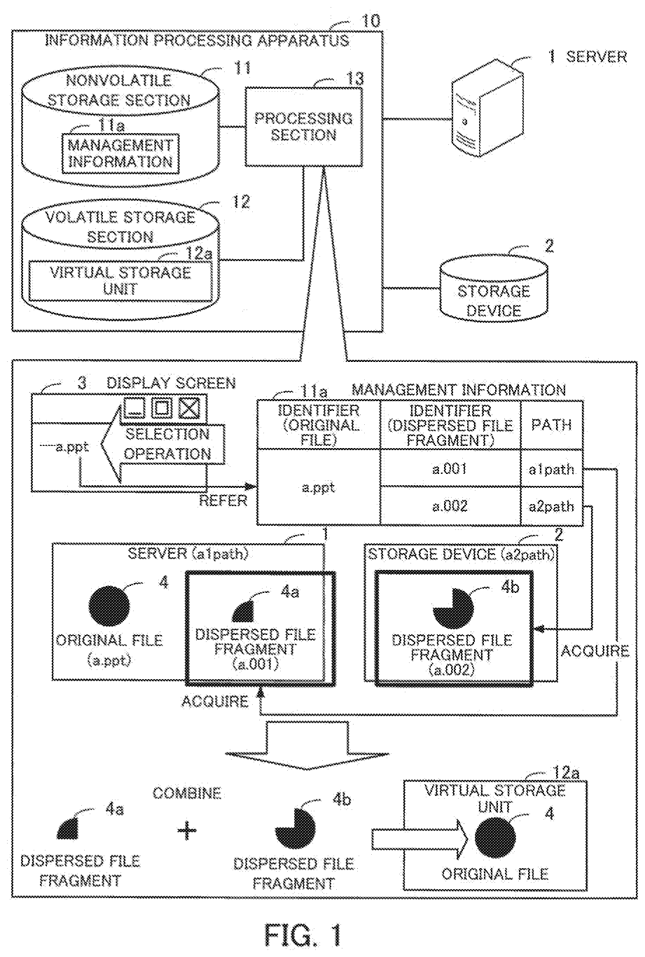

FIG. 1 illustrates an example of an information processing system according to a first embodiment. In the example of FIG. 1, an information processing apparatus 10 generates an original file according to selection operation by a user. The information processing apparatus 10 may perform an original file generation process by executing a program in which a procedure for the original file generation process is described.

A server 1 and a storage device 2 are connected to the information processing apparatus 10. For example, the server 1 is connected to the information processing apparatus 10 via a network. The server 1 stores an original file 4 whose file name is “a.ppt” and first data which is part of a plurality of dispersed file fragments obtained by dividing the original file 4. For example, the plurality of dispersed file fragments are generated by dividing the original file 4 by a secret sharing method.

With the secret sharing method, a file is encrypted and is divided into a plurality of dispersed file fragments. Furthermore, the original file is restored by combining the plurality of dispersed file fragments obtained by the division. For example, assume here that the original file 4 is divided into a dispersed file fragment 4a whose file name is “a.001” and a dispersed file fragment 4b whose file name is “a.002”. The dispersed file fragments 4a and 4b may have the same size or different sizes. The server 1 stores the dispersed file fragment 4a as the first data.

The storage device 2 may be a device connected to the information processing apparatus 10 or a storage device included in the information processing apparatus 10. The storage device 2 stores second data corresponding to the dispersed file fragments obtained by dividing the original file 4 except the first data. The storage device 2 stores the dispersed file fragment 4b as the second data.

The information processing apparatus 10 includes a nonvolatile storage section 11, a volatile storage section 12, and a processing section 13. The nonvolatile storage section 11 is, for example, a storage device included in the information processing apparatus 10. The volatile storage section 12 is, for example, a memory included in the information processing apparatus 10. The processing section 13 is, for example, a processor or an operational circuit included in the information processing apparatus 10.

The nonvolatile storage section 11 stores management information 11a. The management information 11a records, in association with an identifier of the original file 4, an identifier of each of the dispersed file fragments 4a and 4b obtained by dividing the original file 4 and distributedly stored in the plurality of storage devices and a path indicative of a storage location of each of the dispersed file fragments 4a and 4b. An identifier of the original file 4 is, for example, the file name of the original file 4. Furthermore, an identifier of each of the dispersed file fragments 4a and 4b is, for example, a file name of each of the dispersed file fragments 4a and 4b.

In the management information 11a, the identifier “a.001” and the identifier “a.002” are associated with the identifier “a.ppt”. Furthermore, the path “a1path” indicative of the storage location of the dispersed file fragment 4a stored in the server 1 is associated with the identifier “a.001”. In addition, the path “a2path” indicative of the storage location of the dispersed file fragment 4b stored in the storage device 2 is associated with the identifier “a.002”.

The volatile storage section 12 includes a virtual storage unit 12a. The virtual storage unit 12a is part of a storage area of the volatile storage section 12 and is used by the processing section 13 as a virtual storage unit.

The processing section 13 refers to the management information 11a and displays the identifier of the original file 4. For example, the processing section 13 displays on a display screen 3 the file name “a.ppt” of the original file 4 as the identifier of the original file 4. If selection operation is performed on the identifier of the original file 4, then the processing section 13 acquires the dispersed file fragments 4a and 4b corresponding to the original file 4 on the basis of the identifiers of the dispersed file fragments 4a and 4b and the paths indicative of the storage locations of the dispersed file fragments 4a and 4b.

For example, if the identifier “a.ppt” of the original file 4 is selected, then the processing section 13 refers to the management information 11a and specifies the identifier “a.001” and the identifier “a.002” corresponding to the identifier “a.ppt”. Furthermore, the processing section 13 acquires the dispersed file fragment “a.001” according to the path “a1path” corresponding to the dispersed file fragment “a.001”. That is to say, the processing section 13 acquires the dispersed file fragment 4a from the server 1. In addition, the processing section 13 acquires the dispersed file fragment “a.002” according to the path “a2path” corresponding to the dispersed file fragment “a.002”. That is to say, the processing section 13 acquires the dispersed file fragment 4b from the storage device 2.

The processing section 13 combines the dispersed file fragments 4a and 4b acquired to generate the original file 4. Furthermore, the processing section 13 stores the original file 4 generated in the virtual storage unit 12a in the volatile storage section 12.

With the above information processing apparatus 10, the identifier of the original file 4 is displayed, the displayed identifier is selected, and the original file 4 is generated. Because the identifier of the original file 4 is displayed, the user grasps that the original file 4 may be used in the information processing apparatus 10. Furthermore, the original file 4 is generated after the identifier is selected, and thus an original file not yet used is not held in the information processing apparatus 10. As a result, even if the information processing apparatus 10 is stolen, an original file not used does not leak out. This improves security. In addition, the storage capacity is less consumed as an original file not used is not stored.

Furthermore, when the processing section 13 acquires instructions to close the original file 4, the processing section 13 may delete the original file 4 from the virtual storage unit 12a. As a result, the original file 4 is not held in the information processing apparatus 10 when the use of the original file 4 ends. This improves security.

In addition, the processing section 13 may generate the original file 4 if the original file 4 is not stored in the virtual storage unit 12a. By doing so, the original file 4 is not duplicated in the virtual storage unit 12a.

Moreover, the processing section 13 may generate a plurality of updated dispersed file fragments obtained by dividing an updated file obtained by updating the original file 4. Furthermore, the processing section 13 may replace the dispersed file fragments 4a and 4b distributedly stored in the plurality of storage devices with the plurality of updated dispersed file fragments. By doing so, the update of the original file 4 is reflected in the dispersed file fragments.

In addition, an identifier of a folder corresponding to the identifier of the original file 4 may be recorded in the management information 11a. In this connection, the processing section 13 may display the identifier of the original file 4 as an identifier of a file included in the folder corresponding to the identifier of the original file 4. By doing so, identifiers are displayed according to folders and the visibility of the identifiers is improved. In addition, the user is able to open the original file 4 by the same operation as the user opens an ordinary file. This improves usability.

Another storage device in which the dispersed file fragment 4a is stored may be used in place of the server 1 in the above example.

### Second Embodiment

A second embodiment will now be described. In a second embodiment, an original file divided by the secret sharing method is restored according to selection operation by a user.

With the secret sharing method, for example, an encrypted original file is divided into a plurality of dispersed file fragments. In addition, the original file is generated by combining the plurality of dispersed file fragments. That is to say, the original file is not generated from part of the plurality of dispersed file fragments. Accordingly, security is improved by separately saving the plurality of dispersed file fragments.

The user may use the original file as the plurality of dispersed file fragments are combined on a user terminal. If the user terminal which stores the original file is stolen, then the original file leaks out. Accordingly, it is desirable that the user terminal does not store the original file not being used. Therefore, in a second embodiment there is provided an information processing system in which the original file is stored in the user terminal only at the time of using it.

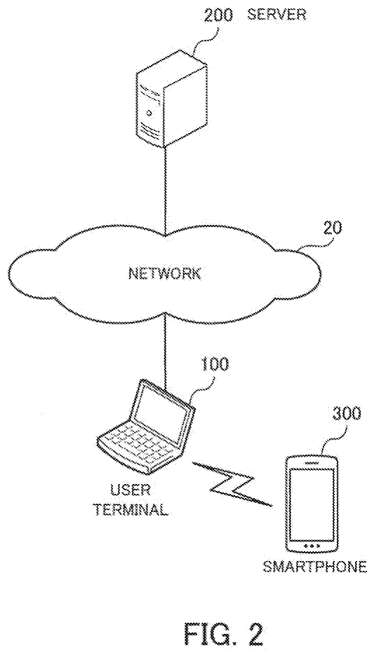

FIG. 2 illustrates an example of the structure of a system according to a second embodiment. A user terminal 100 is connected to a server 200 via a network 20. One of dispersed file fragments obtained by dividing an original file in two by the secret sharing method is stored in the user terminal 100 and the other dispersed file fragment and the original file are stored in the server 200.

The user terminal 100 acquires the dispersed file fragment from the server 200, combines the acquired dispersed file fragment and the dispersed file fragment stored in the user terminal 100, and generates the original file. Furthermore, the user terminal 100 copies the dispersed file fragment stored in the server 200 to a smartphone 300. As a result, if the network 20 is not accessible to the user terminal 100, then the user terminal 100 acquires the dispersed file fragment from the smartphone 300 by radio communication and generates the original file.

In order to reduce the size of data transmitted via the network 20 or radio communication, the user terminal 100 stores a dispersed file fragment which is larger in size between the two dispersed file fragments obtained by dividing the original file. In addition, the server 200 and the smartphone 300 store the other dispersed file fragment which is smaller in size between the two dispersed file fragments obtained by dividing the original file.

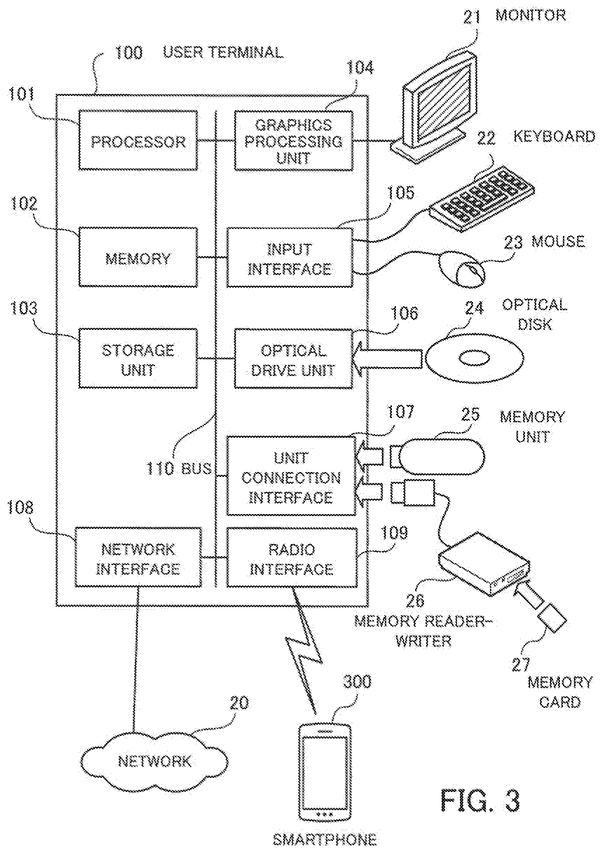

FIG. 3 illustrates an example of a hardware configuration of the user terminal. The whole of the user terminal 100 is controlled by a processor 101. A memory 102 and a plurality of peripheral units are connected to the processor 101 via a bus 110. The processor 101 may be a multiprocessor. The processor 101 is a central processing unit (CPU), a micro processing unit (MPU), a digital signal processor (DSP), or the like. At least part of functions which the processor 101 realizes by executing programs may be realized by an electronic circuit such as an application specific integrated circuit (ASIC) or a programmable logic device (PLD).

The memory 102 is used as main storage of the user terminal 100. The memory 102 temporarily stores at least part of an operating system (OS) program or an application program executed by the processor 101. In addition, the memory 102 stores various pieces of data which the processor 101 uses for performing a process. A volatile semiconductor memory, such as a random access memory (RAM), is used as the memory 102.

The plurality of peripheral units connected to the bus 110 are a storage unit 103, a graphics processing unit 104, an input interface 105, an optical drive unit 106, a unit connection interface 107, a network interface 108, and a radio interface 109.

The storage unit 103 electrically or magnetically writes data to and reads out data from a built-in record medium. The storage unit 103 is used as auxiliary storage of the user terminal 100. The storage unit 103 stores the OS program, application programs, and various pieces of data. A hard disk drive (HDD), a solid state drive (SSD), or the like is used as the storage unit 103.

A monitor 21 is connected to the graphics processing unit 104. The graphics processing unit 104 displays an image on a screen of the monitor 21 in accordance with an instruction from the processor 101. The monitor 21 is a display unit using an organic electroluminescence (EL), a liquid crystal display unit, or the like.

A keyboard 22 and a mouse 23 are connected to the input interface 105. The input interface 105 transmits to the processor 101 a signal transmitted from the keyboard 22 or the mouse 23. The mouse 23 is an example of a pointing device and another pointing device, such as a touch panel, a tablet, a touch pad, or a track ball, may be used.

The optical drive unit 106 reads data recorded on an optical disk 24 by the use of a laser beam or the like. The optical disk 24 is a portable record medium on which recorded data is read by the reflection of light. The optical disk 24 is a digital versatile disc (DVD), a DVD-RAM, a compact disc read only memory (CD-ROM), a CD-recordable(R)/rewritable(RW), or the like.

The unit connection interface 107 is a communication interface used for connecting peripheral units to the user terminal 100. For example, a memory unit 25 and a memory reader-writer 26 are connected to the unit connection interface 107. The memory unit 25 is a record medium having the function of communicating with the unit connection interface 107. The memory reader-writer 26 is a unit which writes data to or reads out data from a memory card 27. The memory card 27 is a card-type record medium.

The network interface 108 is connected to the network 20. The network interface 108 transmits data to or receives data from another computer or a communication apparatus via the network 20.

The radio interface 109 communicates with the smartphone 300 by short-range radio communication. A communication standard used by the radio interface 109 is Bluetooth (registered trademark) or the like.

The user terminal 100 realizes the processing functions in the second embodiment by the above hardware configuration. The information processing apparatus 10 described in the first embodiment is also realized by the same hardware that makes up the user terminal 100 illustrated in FIG. 3. Furthermore, the server 200 is also realized by the same hardware that makes up the user terminal 100. However, the radio interface 109 may be omitted from the server 200. In addition, the processor 101 is an example of the processing section 13 described in the first embodiment. Moreover, the memory 102 is an example of the volatile storage section 12 described in the first embodiment. Furthermore, the storage unit 103 is an example of the storage device 2 and the nonvolatile storage section 11 described in the first embodiment.

The user terminal 100 realizes the processing functions in the second embodiment by executing a program recorded in, for example, a computer-readable record medium. The program in which the contents of a process the user terminal 100 performs are described is recorded in various record media. For example, the program which is to be executed by the user terminal 100 is stored in the storage unit 103. The processor 101 loads at least part of the program stored in the storage unit 103 into the memory 102 and executes it. Furthermore, the program which is to be executed by the user terminal 100 may be recorded on a portable record medium, such as the optical disk 24, the memory unit 25, or the memory card 27. The program recorded on a portable record medium is installed in the storage unit 103 and then is executed, under the control of, for example, the processor 101. In addition, the processor 101 may read out the program directly from a portable record medium and execute it.

A hardware configuration of the smartphone 300 used for storing a dispersed file fragment will now be described. The smartphone 300 is an example of a storage device used in place of the server 1 described in the first embodiment.

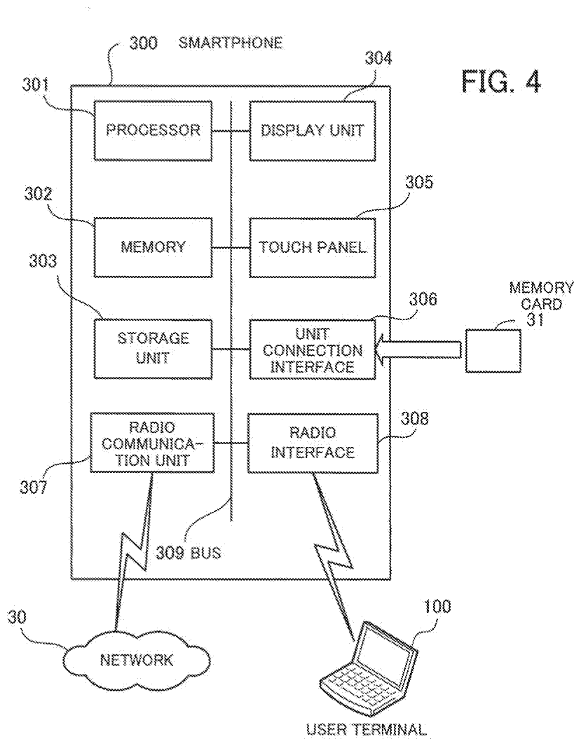

FIG. 4 illustrates an example of a hardware configuration of the smartphone. The whole of the smartphone 300 is controlled by a processor 301. A memory 302 and a plurality of peripheral units are connected to the processor 301 via a bus 309. The processor 301 may be a multiprocessor. The processor 301 is a CPU, an MPU, a DSP, or the like. At least part of functions which the processor 301 realizes by executing programs may be realized by an electronic circuit such as an ASIC or a PLD.

The memory 302 is used as main storage of the smartphone 300. The memory 302 temporarily stores at least part of an OS program or an application program executed by the processor 301. In addition, the memory 302 stores various pieces of data which the processor 301 uses for performing a process. A volatile semiconductor memory, such as a RAM, is used as the memory 302.

The plurality of peripheral units connected to the bus 309 are a storage unit 303, a display unit 304, a touch panel 305, a unit connection interface 306, a radio communication unit 307, and a radio interface 308.

The storage unit 303 electrically or magnetically writes data to and reads out data from a built-in record medium. The storage unit 303 is used as auxiliary storage of the smartphone 300. The storage unit 303 stores the OS program, application programs, and various pieces of data. A flash memory or the like is used as the storage unit 303.

The display unit 304 displays an image in accordance with an instruction from the processor 301. The display unit 304 is a display unit using an organic EL, a liquid crystal display unit, or the like.

The touch panel 305 is arranged at the front of a screen of the display unit 304. The touch panel 305 detects a pressed position on the screen and transmits to the processor 301 a signal indicative of the position.

The unit connection interface 306 is a communication interface used for connecting peripheral units to the smartphone 300. For example, a memory card 31 is connected to the unit connection interface 306. The memory card 31 is a card-type record medium having the function of communicating with the unit connection interface 306.

The radio communication unit 307 is a network interface used for performing radio communication. The radio communication unit 307 is connected to a network 30. The radio communication unit 307 transmits data to or receives data from another computer or a communication apparatus via the network 30.

The radio interface 308 communicates with the user terminal 100 by short-range radio communication. The radio interface 308 uses the same communication standard as the radio interface 109 of the user terminal 100 uses.

The functions of the user terminal 100 will now be described in detail.

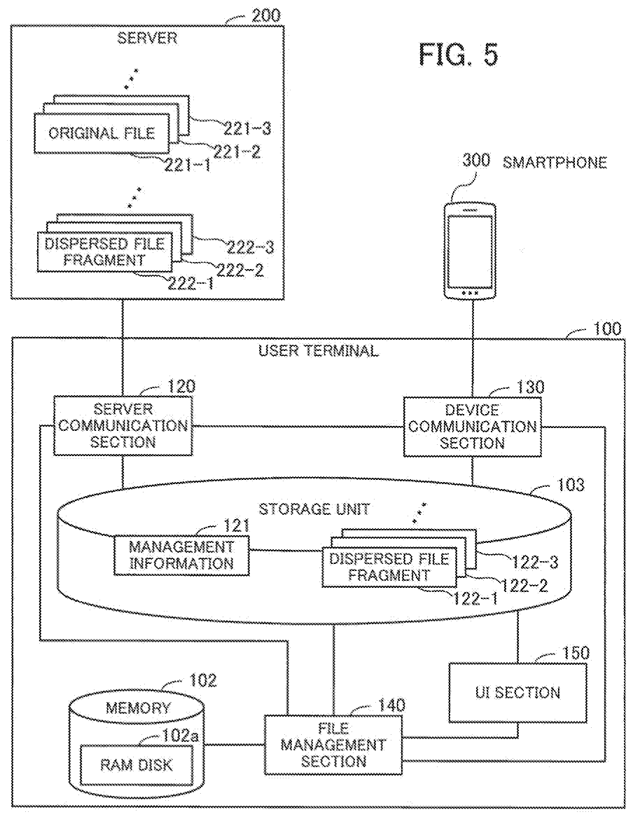

FIG. 5 is a block diagram illustrative of an example of the functions of the user terminal. A RAM disk 102a is included in the memory 102 of the user terminal 100.

The RAM disk 102a is auxiliary storage reproduced by part of a storage area of the memory 102 and software. The RAM disk 102a stores an original file generated by a file management section 140.

Furthermore, the storage unit 103 of the user terminal 100 stores management information 121 and dispersed file fragments 122-1, 122-2, 122-3, Information regarding original files 221-1, 221-2, 221-3, . . . stored in the server 200 is recorded in the management information 121. If each of the original files 221-1, 221-2, 221-3, . . . is divided by the secret sharing method, then the dispersed file fragments 122-1, 122-2, 122-3, . . . and dispersed file fragments 222-1, 222-2, 222-3, . . . are generated respectively. The dispersed file fragments 122-1, 122-2, 122-3, . . . are larger in size than the dispersed file fragments 222-1, 222-2, 222-3, . . . .

In the management information 121, an identifier of an original file, an identifier of each dispersed file fragment generated by dividing the original file, a path indicative of a storage location of each dispersed file fragment, and an identifier of a folder corresponding to the identifier of the original file are associated with one another. In the management information 121, for example, an identifier of the original file 221-1, an identifier of the dispersed file fragment 122-1, and an identifier of the dispersed file fragment 222-1 are associated with one another. Furthermore, in the management information 121, for example, the identifier of the original file 221-1, a path indicative of a storage location of the dispersed file fragment 122-1, and a path indicative of a storage location of the dispersed file fragment 222-1 are associated with one another. In addition, in the management information 121, for example, the identifier of the original file 221-1 and an identifier of a determined folder are associated with each other. For example, the identifier of the original file 221-1, the identifier of the dispersed file fragment 122-1, and the identifier of the dispersed file fragment 222-1 are the file names of the original file 221-1, the dispersed file fragment 122-1, and the dispersed file fragment 222-1 respectively. Moreover, for example, an identifier of a folder is a path indicative of a storage location of the folder.

Furthermore, the user terminal 100 has a server communication section 120, a device communication section 130, the file management section 140, and a user interface (UI) section 150 as functions realized by the processor 101 executing programs.

The server communication section 120 transmits data to and receives data from the server 200. The server communication section 120 refers to the management information 121 to specify a path indicative of a storage location of a dispersed file fragment (for example, the dispersed file fragment 222-1) stored in the server 200. Furthermore, the server communication section 120 acquires the dispersed file fragment 222-1 on the basis of the specified path.

In addition, if an original file (for example, the original file 221-1) is updated by the file management section 140, then the server communication section 120 updates the original file 221-1 and the dispersed file fragment 222-1 stored in the server 200. The server communication section 120 replaces the original file 221-1 stored in the server 200 with an updated file. Moreover, the server communication section 120 replaces the dispersed file fragment 222-1 stored in the server 200 with the smaller one of two dispersed file fragments obtained by dividing the updated file in two.

The device communication section 130 transmits data to and receives data from the smartphone 300. For example, the device communication section 130 transmits to the smartphone 300 the dispersed file fragments 222-1, 222-2, 222-3, . . . which the server communication section 120 acquires from the server 200.

Furthermore, the device communication section 130 refers to the management information 121 to specify a path indicative of a storage location of a dispersed file fragment (for example, the dispersed file fragment 222-1) stored in the smartphone 300. In addition, the device communication section 130 acquires the dispersed file fragment 222-1 on the basis of the specified path.

Moreover, if an original file (for example, the original file 221-1) is updated by the file management section 140, then the device communication section 130 updates the dispersed file fragment 222-1 stored in the smartphone 300. The device communication section 130 replaces the dispersed file fragment 222-1 stored in the smartphone 300 with the smaller one of two dispersed file fragments obtained by dividing an updated file in two.

The file management section 140 generates or divides an original file. For example, the file management section 140 generates an original file by combining a dispersed file fragment acquired by the server communication section 120 or the device communication section 130 and a dispersed file fragment stored in the storage unit 103. The file management section 140 stores the generated original file in the RAM disk 102a.

When an original file (for example, the original file 221-1) is closed, the file management section 140 deletes the original file 221-1 from the RAM disk 102a. If the original file 221-1 to be closed is updated, then the file management section 140 divides an updated file to generate two dispersed file fragments. The file management section 140 replaces the dispersed file fragment 122-1 stored in the storage unit 103 with the larger one of the two dispersed file fragments obtained by dividing the updated file. In addition, the file management section 140 causes the server communication section 120 to replace the dispersed file fragment 222-1 stored in the server 200 with the other dispersed file fragment. Furthermore, the file management section 140 causes the device communication section 130 to replace the dispersed file fragment 222-1 stored in the smartphone 300 with the other dispersed file fragment. Moreover, the file management section 140 causes the server communication section 120 to replace the original file 221-1 stored in the server 200 with the updated file.

In addition, the file management section 140 updates information recorded in the management information 121. For example, if a new original file is generated, then the file management section 140 records a record of the generated original file in the management information 121. Furthermore, for example, if an original file or a dispersed file fragment is updated, then the file management section 140 updates information regarding the original file or the dispersed file fragment in the management information 121.

The UI section 150 displays the identifiers of the original files 221-1, 221-2, 221-3, . . . and accepts selection operation by the user. For example, the UI section 150 retrieves an original file corresponding to a selected folder from the management information 121. The UI section 150 displays an identifier of the retrieved original file as an identifier of a file included in the corresponding folder. If the UI section 150 accepts selection operation on an identifier (for example, selection operation on the identifier of the original file 221-1), then the UI section 150 causes the file management section 140 to generate the original file 221-1.

The server 200 stores the original files 221-1, 221-2, 221-3, . . . and the dispersed file fragments 222-1, 222-2, 222-3, . . . in a storage unit or the like. The smartphone 300 stores the dispersed file fragments 222-1, 222-2, 222-3, . . . acquired from the device communication section 130 in the storage unit 303, the memory card 31, or the like.

The RAM disk 102a is an example of the virtual storage unit 12a described in the first embodiment. In addition, each of the dispersed file fragments 222-1, 222-2, 222-3, . . . is an example of the first data described in the first embodiment and each of the dispersed file fragments 122-1, 122-2, 122-3, . . . is an example of the second data described in the first embodiment.

Lines in FIG. 5 which connect the components indicate part of communication paths. Communication paths other than those illustrated in FIG. 5 may be set.

Furthermore, for example, the function of a component illustrated in FIG. 5 is realized by causing a computer to execute a program module corresponding to the component.

The management information 121 stored in the storage unit 103 will now be described.

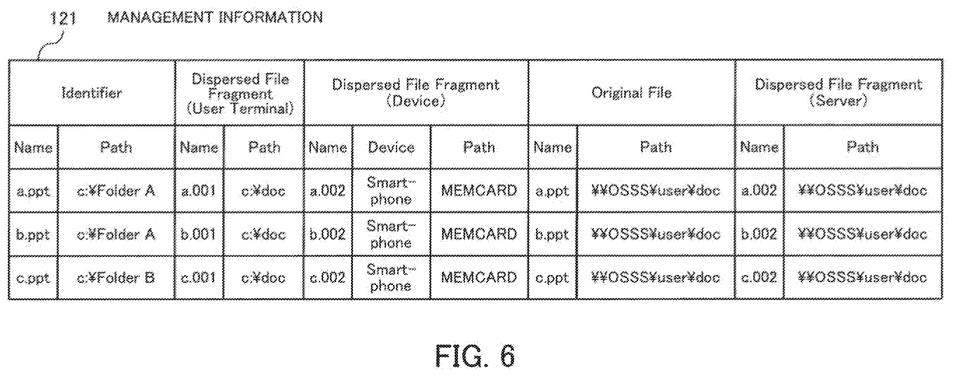

FIG. 6 illustrates an example of the management information. “Identifier,” “Dispersed File Fragment (User Terminal),” “Dispersed File Fragment (Device),” “Original File,” and “Dispersed File Fragment (Server)” columns are set in the management information 121.

Information regarding an identifier of a corresponding original file is recorded in the “Identifier” column. The “Identifier” column includes “Name” and “Path” items. The name of an identifier is set in the “Name” item included in the “Identifier” column. The name of an identifier is, for example, a file name of a corresponding original file. A path indicative of a folder corresponding to an identifier is set in the “Path” item included in the “Identifier” column. A folder corresponding to an identifier may be a virtual folder not having an entity in an area designated by a path.

Information regarding the dispersed file fragments 122-1, 122-2, 122-3, . . . stored in the storage unit 103 of the user terminal 100 is recorded in the “Dispersed File Fragment (User Terminal)” column. The “Dispersed File Fragment (User Terminal)” column includes “Name” and “Path” items. File names of the dispersed file fragments 122-1, 122-2, 122-3, . . . are set in the “Name” item included in the “Dispersed File Fragment (User Terminal)” column. Paths indicative of storage locations of the dispersed file fragments 122-1, 122-2, 122-3, . . . are set in the “Path” item included in the “Dispersed File Fragment (User Terminal)” column.

Information regarding the dispersed file fragments 222-1, 222-2, 222-3, . . . stored in a device (smartphone 300) is recorded in the “Dispersed File Fragment (Device)” column. The “Dispersed File Fragment (Device)” column includes “Name,” “Device,” and “Path” items. File names of the dispersed file fragments 222-1, 222-2, 222-3, . . . are set in the “Name” item included in the “Dispersed File Fragment (Device)” column. The type of a device which stores the dispersed file fragments 222-1, 222-2, 222-3, . . . is set in the “Device” item included in the “Dispersed File Fragment (Device)” column. Paths indicative of storage locations of the dispersed file fragments 222-1, 222-2, 222-3, . . . stored in the smartphone 300 are set in the “Path” item included in the “Dispersed File Fragment (Device)” column.

Information regarding the original files 221-1, 221-2, 221-3, . . . stored in the server 200 is recorded in the “Original File” column. The “Original File” column includes “Name” and “Path” items. File names of the original files 221-1, 221-2, 221-3, . . . are set in the “Name” item included in the “Original File” column. Paths indicative of storage locations of the original files 221-1, 221-2, 221-3, . . . are set in the “Path” item included in the “Original File” column.

Information regarding the dispersed file fragments 222-1, 222-2, 222-3, . . . stored in the server 200 is recorded in the “Dispersed File Fragment (Server)” column. The “Dispersed File Fragment (Server)” column includes “Name” and “Path” items. The file names of the dispersed file fragments 222-1, 222-2, 222-3, . . . are set in the “Name” item included in the “Dispersed File Fragment (Server)” column. Paths indicative of storage locations of the dispersed file fragments 222-1, 222-2, 222-3, . . . stored in the server 200 are set in the “Path” item included in the “Dispersed File Fragment (Server)” column.

A screen display by the UI section 150 will now be described.

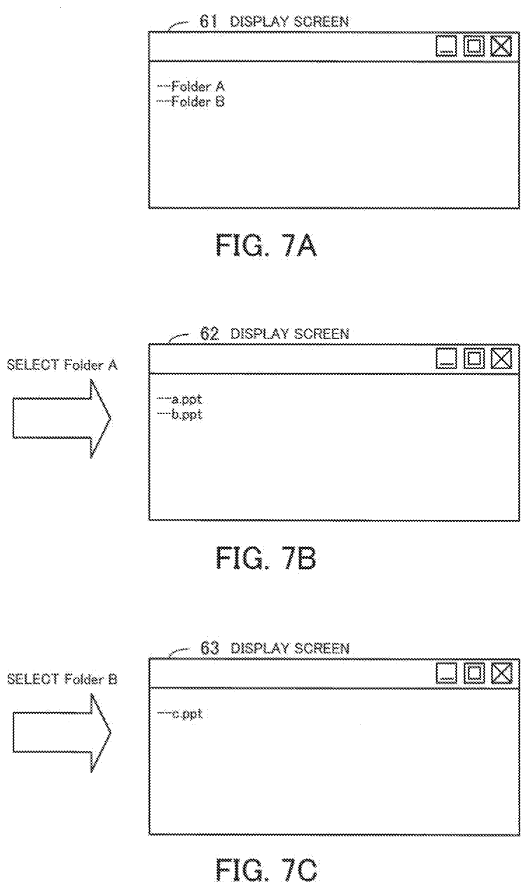

FIGS. 7A to 7C illustrate an example of a display screen. The UI section 150 displays the following display screens on the monitor 21 and allow the user to select an original file to be opened.

As illustrated in FIG. 7A, the UI section 150 displays a display screen 61 on the monitor 21. Folder names set in the “Path” item included in the “Identifier” column of the management information 121 are included on the display screen 61. For example, “Folder A” and “Folder B” are included on the display screen 61. The UI section 150 accepts selection operation on a folder name included on the display screen 61.

For example, if “Folder A” is selected on the display screen 61, then the UI section 150 displays a display screen 62 on the monitor 21, as illustrated in FIG. 7B. Identifiers of files included in “Folder A” are displayed on the display screen 62. The identifiers displayed on the display screen 62 include an identifier of an original file for which the path “Folder A” is set in the “Path” item included in the “Identifier” column of the management information 121. For example, “a.ppt” and “b.ppt” are included on the display screen 62. The UI section 150 accepts selection operation on an identifier included on the display screen 62. For example, if “a.ppt” included on the display screen 62 is selected, then the UI section 150 causes the file management section 140 to open “a.ppt”.

Furthermore, for example, if “Folder B” is selected on the display screen 61, then the UI section 150 displays a display screen 63 on the monitor 21, as illustrated in FIG. 7C. Identifiers of files included in “Folder B” are displayed on the display screen 63. The identifiers displayed on the display screen 63 include an identifier of an original file for which the path “Folder B” is set in the “Path” item included in the “Identifier” column of the management information 121. For example, “c.ppt” is included on the display screen 63. For example, if “c.ppt” included on the display screen 63 is selected, then the UI section 150 causes the file management section 140 to open “c.ppt”.

A method for using an original file on the user terminal 100 will now be described.

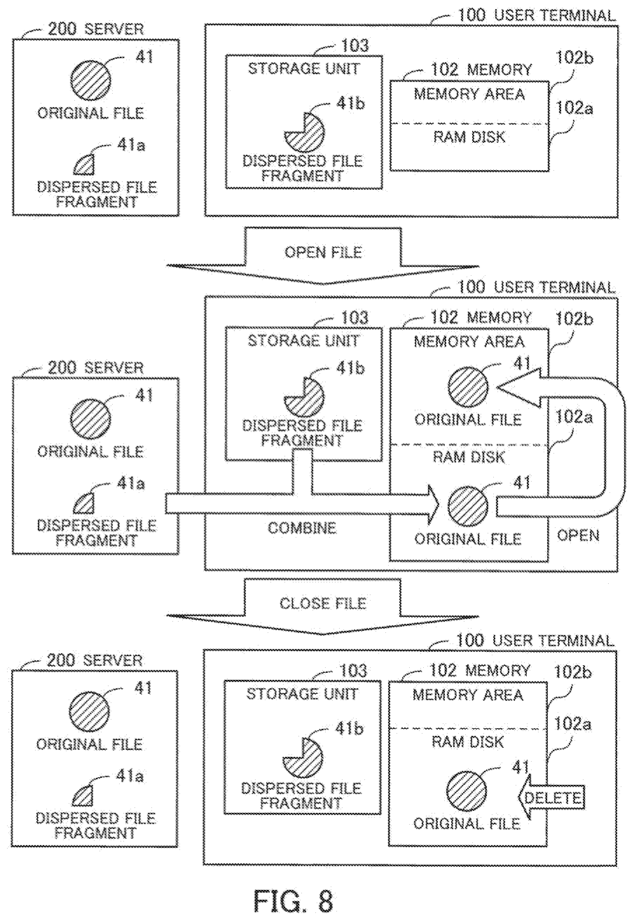

FIG. 8 illustrates an example of a method for opening and closing an original file. In the following example, an original file 41 divided into dispersed file fragments 41a and 41b is opened by the user terminal 100. The dispersed file fragment 41a is smaller in file size than the dispersed file fragment 41b.

The RAM disk 102a and a memory area 102b are included in the memory 102 of the user terminal 100. A file stored in the memory area 102b is manipulated by a program executed by the user terminal 100 to be viewed or edited. That is to say, storing a file in the memory area 102b indicates that the file is opened. Deleting a file from the memory area 102b indicates that the file is closed. The dispersed file fragment 41b is stored in the storage unit 103 of the user terminal 100. The original file 41 and the dispersed file fragment 41a are stored in the server 200.

The file management section 140 causes the server communication section 120 to acquire the dispersed file fragment 41a from the server 200. The file management section 140 generates the original file 41 by combining the dispersed file fragment 41a and the dispersed file fragment 41b, and stores the generated original file 41 in the RAM disk 102a. Furthermore, the file management section 140 stores the original file 41 in the memory area 102b (opens the original file 41).

When the file management section 140 acquires instructions to close the original file 41, the file management section 140 deletes the original file 41 stored in the memory area 102b. In addition, the file management section 140 deletes the original file 41 stored in the RAM disk 102a. The original file 41 stored in the RAM disk 102a may be deleted when the original file 41 is opened (when the original file 41 is stored in the memory area 102b).

The original file 41 is opened in this way by the user terminal 100. Furthermore, when the original file 41 is closed, the original file 41 is deleted from the RAM disk 102a and the memory area 102b. Accordingly, the original file 41 does not remain in the user terminal 100 after its use ends.

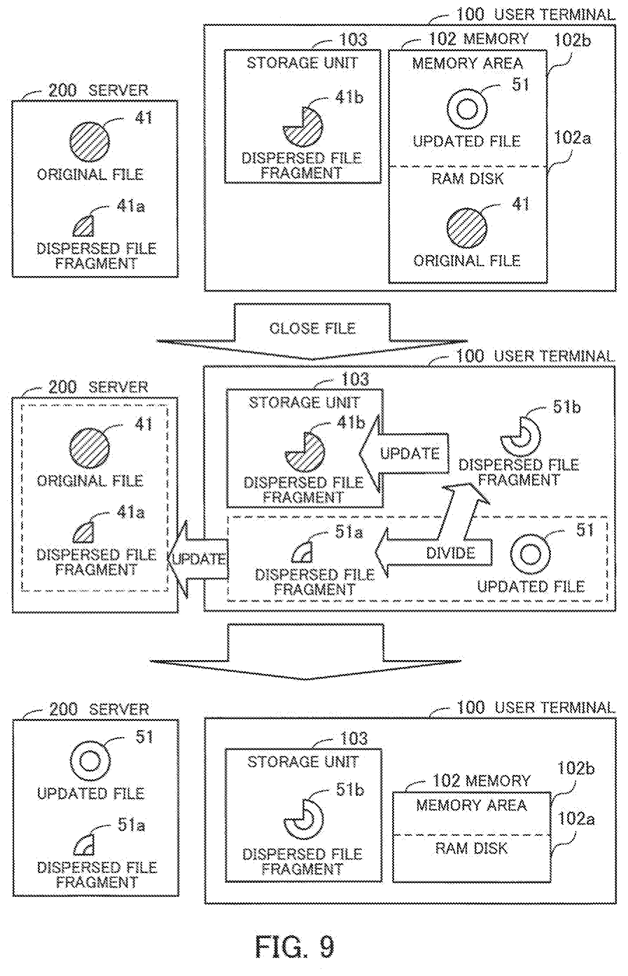

FIG. 9 illustrates an example of a method for updating an original file. In the following example, an original file 41 opened by the user terminal 100 is updated to an updated file 51. In that case, a dispersed file fragment stored in the user terminal 100 and the original file 41 and a dispersed file fragment stored in the server 200 are updated.

In the example of FIG. 9, a dispersed file fragment 41b is stored in the storage unit 103 and the original file 41 and a dispersed file fragment 41a are stored in the server 200. This is the same with the example of FIG. 8. Furthermore, in the example of FIG. 9, the original file 41 is stored in the RAM disk 102a and the updated file 51 obtained by updating the original file 41 is stored in the memory area 102b. The original file 41 stored in the RAM disk 102a may also be updated to the updated file 51.

When the file management section 140 acquires instructions to close the updated file 51, the file management section 140 divides the updated file 51 into dispersed file fragments 51a and 51b. The dispersed file fragment 51a is smaller in file size than the dispersed file fragment 51b. Furthermore, the file management section 140 replaces the dispersed file fragment 41b stored in the storage unit 103 with the dispersed file fragment 51b. In addition, the file management section 140 causes the server communication section 120 to replace the original file 41 and the dispersed file fragment 41a stored in the server 200 with the updated file 51 and the dispersed file fragment 51a respectively. Moreover, the file management section 140 deletes the original file 41 from the RAM disk 102a.

Update of an original file opened by the user terminal 100 is reflected in this way in a dispersed file fragment stored in the user terminal 100 and the original file and a dispersed file fragment stored in the server 200. Each of the dispersed file fragments 51a and 51b is an example of the updated dispersed file fragment described in the first embodiment.

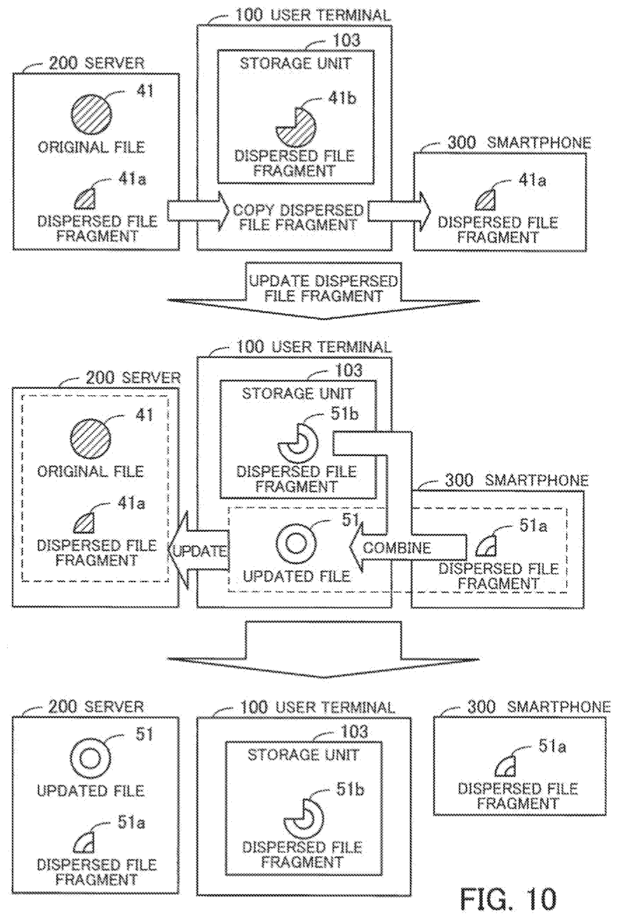

FIG. 10 illustrates an example of a method for copying a dispersed file fragment to the smartphone. In the following example, a dispersed file fragment 41a stored in the server 200 is copied to the smartphone 300.

The server communication section 120 acquires the dispersed file fragment 41a from the server 200. The device communication section 130 transmits the dispersed file fragment 41a to the smartphone 300. The dispersed file fragment 41a is deleted from the user terminal 100.

By doing so, the device communication section 130 is able to acquire the dispersed file fragment 41a from the smartphone 300, instead of acquiring the dispersed file fragment 41a from the server 200 as illustrated in FIG. 8.

If the original file 41 opened by the use of the dispersed file fragment 41a acquired from the smartphone 300 is updated to an updated file 51, then the device communication section 130 updates the dispersed file fragment 41a stored in the smartphone 300 to a dispersed file fragment 51a. Furthermore, the file management section 140 updates a dispersed file fragment 41b stored in the storage unit 103 to a dispersed file fragment 51b. The original file 41 and the dispersed file fragment 41a stored in the server 200 are updated in the following way by the use of the dispersed file fragment 51a stored in the smartphone 300 and the dispersed file fragment 51b stored in the storage unit 103.

The file management section 140 causes the device communication section 130 to acquire the dispersed file fragment 51a from the smartphone 300. The file management section 140 generates the updated file 51 by combining the dispersed file fragment 51a and the dispersed file fragment 51b, and stores the generated updated file 51 in the RAM disk 102a. Furthermore, the file management section 140 causes the server communication section 120 to replace the original file 41 and the dispersed file fragment 41a stored in the server 200 with the updated file 51 and the dispersed file fragment 51a respectively. In addition, the file management section 140 deletes the updated file 51 from the RAM disk 102a. The file management section 140 may cause the device communication section 130 to delete the dispersed file fragment 51a from the smartphone 300.

As stated above, even if the user terminal 100 is in a state in which it is unable to communicate with the server 200 (for example, in an off-line state), an original file is opened by the user terminal 100. In addition, even if an original file opened by the user terminal 100 is updated, the update is reflected in the original file and a dispersed file fragment stored in the server 200 after the user terminal 100 becomes able to communicate with the server 200.

A procedure for a process performed by the user terminal 100 will now be described in detail.

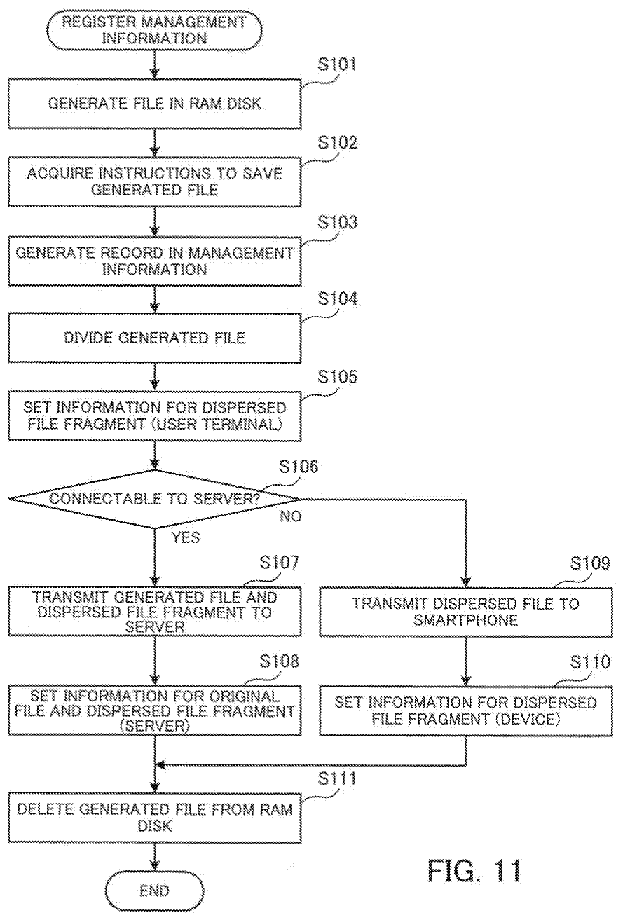

FIG. 11 is a flow chart illustrative of an example of a procedure for registering management information. A process illustrated in FIG. 11 will now be described in order of step number.

(Step S101) The file management section 140 generates a new file (for example, an original file 41). The file management section 140 stores the generated original file 41 in the RAM disk 102a.

(Step S102) The file management section 140 acquires instructions to save the original file 41 generated in step S101.

(Step S103) The file management section 140 generates in the management information 121 a record regarding the original file 41 generated in step S101. The file management section 140 sets a file name of the original file 41 in a “Name” item included in an “Identifier” column of the generated record. Furthermore, the file management section 140 sets a path of a folder corresponding to the original file 41 in a “Path” item included in the “Identifier” column.

(Step S104) The file management section 140 divides the original file 41 generated in step S101 to generate dispersed file fragments 41a and 41b. The file management section 140 stores the generated dispersed file fragment 41b in the storage unit 103.

(Step S105) The file management section 140 sets in the management information 121 information regarding the dispersed file fragment 41b generated in step S104. The file management section 140 sets a file name of the dispersed file fragment 41b in a “Name” item included in a “Dispersed File Fragment (User Terminal)” column of the record regarding the original file 41 recorded in the management information 121. Furthermore, the file management section 140 sets a path indicative of a storage location of the dispersed file fragment 41b in a “Path” item included in the “Dispersed File Fragment (User Terminal)” column of the record regarding the original file 41 recorded in the management information 121.

(Step S106) The server communication section 120 determines whether or not it is connectable to the server 200. If the server communication section 120 determines that it is connectable to the server 200, then step S107 is performed. Furthermore, if the server communication section 120 determines that it is not connectable to the server 200, then step S109 is performed.

(Step S107) The server communication section 120 transmits to the server 200 the original file 41 generated in step S101 and the dispersed file fragment 41a generated in step S104.

(Step S108) The file management section 140 sets in the management information 121 information regarding the original file 41 and the dispersed file fragment 41a transmitted in step S107. The file management section 140 sets a file name of the original file 41 in a “Name” item included in an “Original File” column of the record regarding the original file 41 recorded in the management information 121. Furthermore, the file management section 140 sets a path indicative of a storage location of the original file 41 in a “Path” item included in the “Original File” column of the record regarding the original file 41 recorded in the management information 121.

In addition, the file management section 140 sets a file name of the dispersed file fragment 41a in a “Name” item included in a “Dispersed File Fragment (Server)” column of the record regarding the original file 41 recorded in the management information 121. Furthermore, the file management section 140 sets a path indicative of a storage location of the dispersed file fragment 41a in a “Path” item included in the “Dispersed File Fragment (Server)” column of the record regarding the original file 41 recorded in the management information 121. Then, the process proceeds to step S111.

(Step S109) The device communication section 130 transmits to the smartphone 300 the dispersed file fragment 41a generated in step S104.

(Step S110) The file management section 140 sets in the management information 121 information regarding the dispersed file fragment 41a transmitted in step S109. The file management section 140 sets a file name of the dispersed file fragment 41a in a “Name” item included in a “Dispersed File Fragment (Device)” column of the record regarding the original file 41 recorded in the management information 121. Furthermore, the file management section 140 sets “smartphone” in a “Device” item included in the “Dispersed File Fragment (Device)” column of the record regarding the original file 41 recorded in the management information 121. In addition, the file management section 140 sets a path indicative of a storage location of the dispersed file fragment 41a in a “Path” item included in the “Dispersed File Fragment (Device)” column of the record regarding the original file 41 recorded in the management information 121.

(Step S111) The file management section 140 deletes from the RAM disk 102a the original file 41 generated in step S101.

A file newly generated by the user terminal 100 is registered in this way in the management information 121.

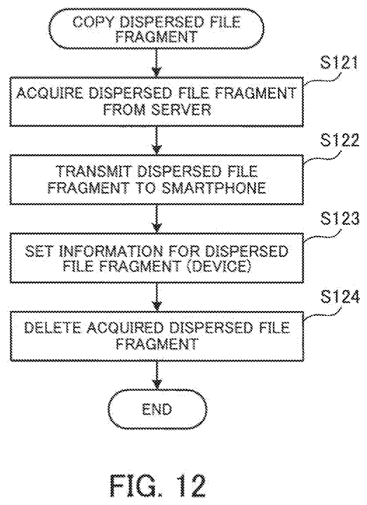

FIG. 12 is a flow chart illustrative of an example of a procedure for copying a dispersed file fragment. A process illustrated in FIG. 12 will now be described in order of step number.

(Step S121) The server communication section 120 acquires from the server 200 a dispersed file fragment (for example, a dispersed file fragment 41a) to be copied to the smartphone 300. For example, the server communication section 120 specifies a path indicative of a storage location of the dispersed file fragment 41a stored in the server 200 by referring to the management information 121. Furthermore, the server communication section 120 acquires the dispersed file fragment 41a from the specified path.

(Step S122) The device communication section 130 transmits to the smartphone 300 the dispersed file fragment 41a acquired from the server 200 in step S121.

(Step S123) The file management section 140 sets in the management information 121 information regarding the dispersed file fragment 41a transmitted in step S122. The file management section 140 sets a file name of the dispersed file fragment 41a in a “Name” item included in a “Dispersed File Fragment (Device)” column of a record corresponding to the dispersed file fragment 41a in the management information 121. Furthermore, the file management section 140 sets a path indicative of a storage location of the dispersed file fragment 41a in a “Path” item included in the “Dispersed File Fragment (Device)” column of the record corresponding to the dispersed file fragment 41a in the management information 121.

(Step S124) The file management section 140 deletes the dispersed file fragment 41a acquired in step S121.

A dispersed file fragment stored in the server 200 is copied in this way to the smartphone 300. As a result, the user terminal 100 is able to open an original file even in an off-line state.

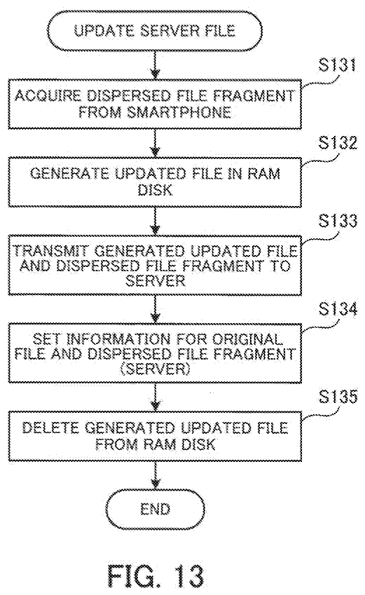

FIG. 13 is a flow chart illustrative of an example of a procedure for updating a server file. A process illustrated in FIG. 13 will now be described in order of step number.

(Step S131) The device communication section 130 acquires from the smartphone 300 a dispersed file fragment (for example, a dispersed file fragment 51a) to be saved in the server 200. For example, the device communication section 130 specifies a path indicative of a storage location of the dispersed file fragment 51a stored in the smartphone 300 by referring to the management information 121. Furthermore, the device communication section 130 acquires the dispersed file fragment 51a from the specified path.

(Step S132) The file management section 140 generates an updated file 51 by combining the dispersed file fragment 51a acquired in step S131 and a dispersed file fragment 51b stored in the storage unit 103. The file management section 140 stores the generated updated file 51 in the RAM disk 102a.

(Step S133) The server communication section 120 transmits to the server 200 the updated file 51 generated in step S132 and the dispersed file fragment 51a acquired from the smartphone 300 in step S131.

(Step S134) The file management section 140 sets in the management information 121 information regarding the updated file 51 and the dispersed file fragment 51a transmitted in step S133. The file management section 140 sets a file name of the updated file 51 in a “Name” item included in an “Original File” column of a record regarding the updated file 51 recorded in the management information 121. Furthermore, the file management section 140 sets a path indicative of a storage location of the updated file 51 in a “Path” item included in the “Original File” column of the record regarding the updated file 51 recorded in the management information 121.

In addition, the file management section 140 sets a file name of the dispersed file fragment 51a in a “Name” item included in a “Dispersed File Fragment (Server)” column of the record regarding the updated file 51 recorded in the management information 121. Moreover, the file management section 140 sets a path indicative of a storage location of the dispersed file fragment 51a in a “Path” item included in the “Dispersed File Fragment (Server)” column of the record regarding the updated file 51 recorded in the management information 121.

(step S135) The file management section 140 deletes the updated file 51 generated in step S132 from the RAM disk 102a.

An original file stored in the server 200 is replaced in this way with a file generated by combining a dispersed file fragment stored in the storage unit 103 and a dispersed file fragment stored in the smartphone 300. In addition, a dispersed file fragment stored in the server 200 is replaced with the dispersed file fragment stored in the smartphone 300. As a result, update of the original file performed in an off-line state is reflected in the original file and the dispersed file fragment stored in the server 200.

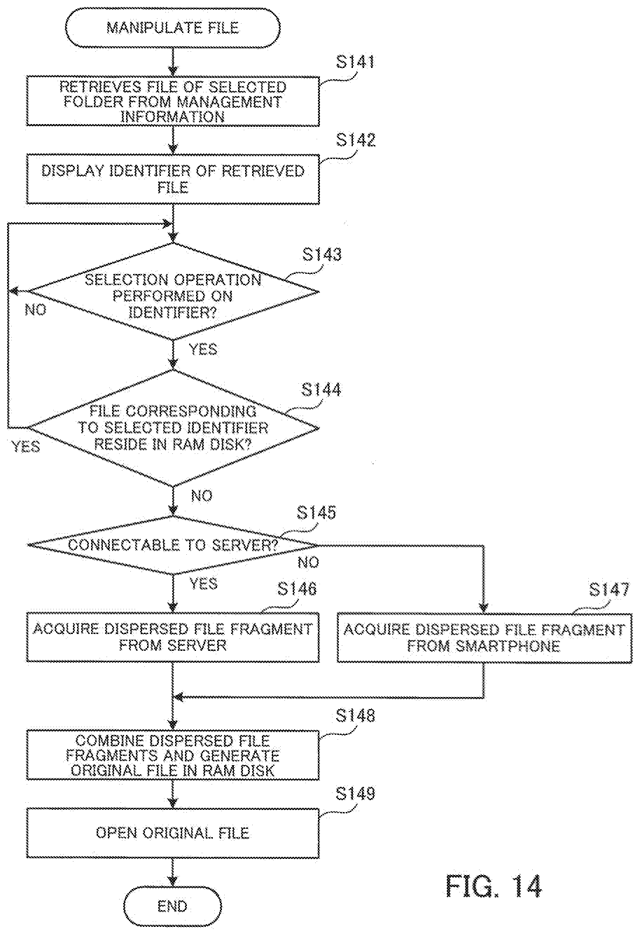

FIG. 14 is a flow chart illustrative of an example of a procedure for manipulating a file. A process illustrated in FIG. 14 will now be described in order of step number.

(Step S141) The UI section 150 retrieves a file of a selected folder from the management information 121. For example, the UI section 150 accepts selection operation on a folder name included on the display screen 61. Furthermore, the UI section 150 retrieves from the management information 121 a record in which a path of the selected folder is set in a “Path” item included in an “Identifier” column.

(Step S142) The UI section 150 displays an identifier of the file retrieved in step S141 as an identifier of the file of the selected folder. For example, the UI section 150 displays a name of an identifier set in a “Name” item included in the “Identifier” column of the record retrieved in step S141.

(Step S143) The UI section 150 determines whether or not selection operation is performed on the displayed identifier. If the UI section 150 determines that selection operation is performed on the displayed identifier, then step S144 is performed. Furthermore, if the UI section 150 determines that selection operation is not performed on the displayed identifier, then step S143 is performed. That is to say, the UI section 150 waits until selection operation is performed on the displayed identifier.

(Step S144) The file management section 140 determines whether or not an original file (for example, an original file 41) corresponding to the identifier selected in step S143 resides in the RAM disk 102a. If the file management section 140 determines that the original file 41 resides in the RAM disk 102a, then step S143 is performed. Furthermore, if the file management section 140 determines that the original file 41 does not reside in the RAM disk 102a, then step S145 is performed.

(Step S145) The server communication section 120 determines whether or not it is connectable to the server 200. If the server communication section 120 determines that it is connectable to the server 200, then step S146 is performed. Furthermore, if the server communication section 120 determines that it is not connectable to the server 200, then step S147 is performed.

(Step S146) The server communication section 120 acquires from the server 200 a dispersed file fragment (dispersed file fragment 41a) corresponding to the original file 41. For example, the server communication section 120 specifies a path indicative of a storage location of the dispersed file fragment 41a stored in the server 200 by referring to the management information 121. Furthermore, the server communication section 120 acquires the dispersed file fragment 41a from the specified path. Then, the process proceeds to step S148.

(Step S147) The device communication section 130 acquires from the smartphone 300 the dispersed file fragment (dispersed file fragment 41a) corresponding to the original file 41. For example, the device communication section 130 specifies a path indicative of a storage location of the dispersed file fragment 41a stored in the smartphone 300 by referring to the management information 121. Furthermore, the device communication section 130 acquires the dispersed file fragment 41a from the specified path.

(Step S148) The file management section 140 generates the original file 41 by combining the dispersed file fragment 41a acquired in step S146 or step S147 and a dispersed file fragment 41b stored in the storage unit 103. The file management section 140 stores the generated original file 41 in the RAM disk 102a.

(Step S149) The file management section 140 opens the original file 41 generated in step S148. For example, the file management section 140 stores the original file 41 in the memory area 102b.

If an identifier of an original file is displayed and the displayed identifier is selected, then the original file is generated in this way. Because the identifier of the original file is displayed, the user is able to grasps a usable original file even if the user terminal 100 does not store the original file. In addition, because identifiers are displayed according to folders, the visibility of the identifiers is improved. Moreover, the user may open the original file by the same operation as the user opens an ordinary file. This improves usability.

Furthermore, after an identifier is selected, an original file is generated. Therefore, an original file not used is not held in the user terminal 100. As a result, the risk of leakage of an original file decreases and security is improved.

In addition, if an original file is already stored in the RAM disk 102a, then the original file is not generated. This avoids duplicating the original file.

The following method is possible as another way for allowing the user to select an original file to be used. All original files which may be used by the user terminal 100 are generated in advance in the RAM disk 102a and identifiers of the original files stored in the RAM disk 102a are displayed. With this method, however, the total size of original files which may be used by the user terminal 100 is limited to the capacity of the RAM disk 102a. On the other hand, in the second embodiment, only an original file selected by the user is generated and is stored in the RAM disk 102a. As a result, consumption of storage capacity is reduced and the total size of original files which may be used by the user terminal 100 increases.

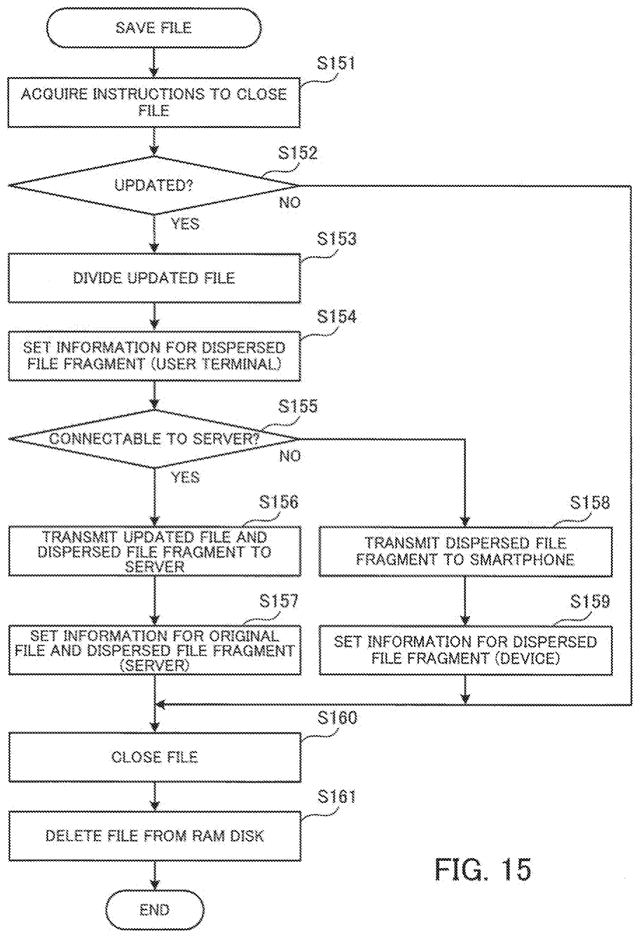

FIG. 15 is a flow chart illustrative of an example of a procedure for saving a file. A process illustrated in FIG. 15 will now be described in order of step number.

(Step S151) The file management section 140 acquires instructions to close a file stored in the memory area 102b.

(Step S152) The file management section 140 determines whether or not the file to be closed is updated. If the file management section 140 determines that the file to be closed is updated (for example, that an original file is updated to an updated file 51), then step S153 is performed. Furthermore, if the file management section 140 determines that the file to be closed is not updated, then step S160 is performed.

(Step S153) The file management section 140 divides the updated file 51 to generate dispersed file fragments 51a and 51b. The file management section 140 replaces a dispersed file fragment 41b stored in the storage unit 103 with the generated dispersed file fragment 51b.

(Step S154) The file management section 140 sets in the management information 121 information regarding the dispersed file fragment 51b generated in step S153. The file management section 140 sets a file name of the dispersed file fragment 51b in a “Name” item included in a “Dispersed File Fragment (User Terminal)” column of a record regarding the original file 41 recorded in the management information 121. Furthermore, the file management section 140 sets a path indicative of a storage location of the dispersed file fragment 51b in a “Path” item included in the “Dispersed File Fragment (User Terminal)” column of the record regarding the original file 41 recorded in the management information 121.

(Step S155) The server communication section 120 determines whether or not it is connectable to the server 200. If the server communication section 120 determines that it is connectable to the server 200, then step S156 is performed. Furthermore, if the server communication section 120 determines that it is no connectable to the server 200, then step S158 is performed.

(Step S156) The server communication section 120 transmits to the server 200 the updated file 51 and the dispersed file fragment 51a generated in step S153.

(Step S157) The file management section 140 sets in the management information 121 information regarding the updated file 51 and the dispersed file fragment 51a transmitted in step S156. The file management section 140 sets a file name of the updated file 51 in a “Name” item included in a “Original File” column of the record regarding the original file 41 recorded in the management information 121. Furthermore, the file management section 140 sets a path indicative of a storage location of the updated file 51 in a “Path” item included in the “Original File” column of the record regarding the original file 41 recorded in the management information 121.

In addition, the file management section 140 sets a file name of the dispersed file fragment 51a in a “Name” item included in a “Dispersed File Fragment (Server)” column of the record regarding the original file 41 recorded in the management information 121. Moreover, the file management section 140 sets a path indicative of a storage location of the dispersed file fragment 51a in a “Path” item included in the “Dispersed File Fragment (Server)” column of the record regarding the original file 41 recorded in the management information 121. Then, the process proceeds to step S160.

(Step S158) The device communication section 130 transmits to the smartphone 300 the dispersed file fragment 51a generated in step S153.

(Step S159) The file management section 140 sets in the management information 121 information regarding the dispersed file fragment 51a transmitted in step S158. The file management section 140 sets a file name of the dispersed file fragment 51a in a “Name” item included in a “Dispersed File Fragment (Device)” column of the record regarding the original file 41 recorded in the management information 121. Furthermore, the file management section 140 sets “smartphone” in a “Device” item included in the “Dispersed File Fragment (Device)” column of the record regarding the original file 41 recorded in the management information 121. In addition, the file management section 140 sets a path indicative of a storage location of the dispersed file fragment 51a in a “Path” item included in the “Dispersed File Fragment (Device)” column of the record regarding the original file 41 recorded in the management information 121.

(Step S160) The file management section 140 closes the file stored in the memory area 102b. For example, the file management section 140 deletes the file stored in the memory area 102b.

(Step S161) The file management section 140 deletes from the RAM disk 102a an original file corresponding to the file deleted in step S160.

If an original file is closed, then the closed original file is deleted in this way from the RAM disk 102a. As a result, when the use of an original file ends, the original file is not held in the user terminal 100. This decreases the risk of leakage of an original file and improves security.

In addition, if an original file to be closed has been updated, then the original file stored in the server 200 is replaced with an updated file. Moreover, a dispersed file fragment stored in the storage unit 103 and a dispersed file fragment stored in the server 200 are also replaced with dispersed file fragments obtained by dividing the updated file. As a result, update of the original file is reflected in the dispersed file fragment stored in the storage unit 103 and the dispersed file fragment stored in the server 200.

### Another Embodiment

In the second embodiment, a dispersed file fragment stored in the server 200 is copied to the smartphone 300. However, a dispersed file fragment stored in the server 200 may be copied to a device other than a smartphone.

For example, a dispersed file fragment stored in the server 200 may be copied to a portable record medium such as the optical disk 24, the memory unit 25, or the memory card 27. In addition, for example, a dispersed file fragment stored in the server 200 may be copied to a smartwatch or a portable music player. Moreover, for example, a dispersed file fragment stored in the server 200 may be copied to a mouse with built-in storage or a headphone with built-in storage. Furthermore, for example, a dispersed file fragment stored in the server 200 may be copied to an integrated circuit (IC) card.

According to an aspect, security is improved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory; and
a processor which is connected to the memory, which refers to management information in which an identifier of each of a plurality of dispersed file fragments obtained by dividing an original file and distributedly stored in a plurality of storage devices and a path indicative of a storage location of the each of the plurality of dispersed file fragments are recorded in association with an identifier of the original file, which displays the identifier of the original file, which acquires, upon selection of the identifier of the original file, the plurality of dispersed file fragments corresponding to the original file based on the identifier of the each of the plurality of dispersed file fragments and the path, and which combines the plurality of dispersed file fragments to generate the original file.

2. The information processing apparatus according to claim 1, further comprising:
a volatile storage section,
wherein the processor uses a partial storage area of the volatile storage section as a virtual storage unit and stores the generated original file in the storage area in the volatile storage section.

3. The information processing apparatus according to claim 2, wherein when the processor acquires instructions to close the original file, the processor deletes the original file from the storage area.

4. The information processing apparatus according to claim 2, wherein when the original file is not stored in the storage area, the processor generates the original file.

5. The information processing apparatus according to claim 1, wherein the processor generates a plurality of updated dispersed file fragments by dividing an updated file obtained by updating the original file and replaces the plurality of dispersed file fragments distributedly stored in the plurality of storage devices with the plurality of updated dispersed file fragments.

6. The information processing apparatus according to claim 1, wherein:
an identifier of a folder corresponding to the identifier of the original file is recorded in the management information; and
the processor displays the identifier of the original file as an identifier of a file included in the folder corresponding to the identifier of the original file.

7. A non-transitory computer-readable recording medium storing therein a computer program that causes a computer to execute a process comprising:
referring to management information in which an identifier of each of a plurality of dispersed file fragments obtained by dividing an original file and distributedly stored in a plurality of storage devices and a path indicative of a storage location of the each of the plurality of dispersed file fragments are recorded in association with an identifier of the original file;
displaying the identifier of the original file;
acquiring, upon selection of the identifier of the original file, the plurality of dispersed file fragments corresponding to the original file based on the identifier of the each of the plurality of dispersed file fragments and the path; and
combining the plurality of dispersed file fragments to generate the original file.

8. An information processing system comprising:
a server which stores an original file and first data corresponding to a part of a plurality of dispersed file fragments obtained by dividing the original file;
a storage device which stores second data corresponding to the plurality of dispersed file fragments except the first data; and
an information processing apparatus which refers to management information in which an identifier of each of the plurality of dispersed file fragments and a path indicative of a storage location of the each of the plurality of dispersed file fragments are recorded in association with an identifier of the original file, which displays the identifier of the original file, which acquires, upon selection of the identifier of the original file, the plurality of dispersed file fragments corresponding to the original file based on the identifier of the each of the plurality of dispersed file fragments and the path, and which combines the plurality of dispersed file fragments to generate the original file.
